(19) United States
(12) Patent Application Publication
(10) Pub. No.: US 2007/0127267 A1
(43) Pub. Date: Jun. 7, 2007

(54) Light guide plate and method for manufacturing same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/472,948

(22) Filed: Jun. 21, 2006

(30) Foreign Application Priority Data
Dec. 2, 2005 (TW) 094142458

(51) Int. Cl. F21V 7/04

(52) U.S. Cl. 362/626

(57) ABSTRACT

A light guide plate (2) includes a light incident surface (205), a bottom surface (201) adjoining the light incident surface, and a light emitting surface (203) opposite to the bottom surface. The bottom surface has a plurality of first V-shaped grooves (2013) defined therein along a plurality of concentric arcs. The light emitting surface has a plurality of second V-shaped grooves (2031) defined therein in parallel with each other.

### BACKGROUND

1. Technical Field

The present invention relates to light guide plates and more particularly, to a light guide plate with high light utilization and uniformity. The present invention also relates to a method for manufacturing the light guide plate.

2. Background

Nowadays, liquid crystal materials are widely utilized in various liquid crystal displays having different sizes for different applications, such as TVs, liquid crystal projectors, mobile telephones, personal digital assistants (PDA), etc. Because liquid crystal itself cannot emit light, light sources must be utilized to illuminate liquid crystal for image display. The light sources are called backlight sources since they are usually configured behind liquid crystal panels. A combination of all components behind the liquid crystal panels, including the light sources, is generally referred to as a backlight module. Usually, the backlight modules can be classified into edge type backlight modules and direct type backlight modules.

A typical edge type backlight module 1 as shown in FIG. 22, includes a light source 11, a light guide plate 12, a reflective plate 13, a first diffusion plate 14, a first prism sheet 15, a second prism sheet 16, and a second diffusion plate 17. The light source is a cold cathode fluorescent lamp (CCFL) and arranged adjacent to a side of the light guide plate 12. The reflective plate 13 is arranged behind the light guide plate 12. The first diffusion plate 14, the first prism sheet 15, the second prism sheet 16 and the second diffusion plate 17 are arranged on the light guide plate 12 in series.

Referring to FIGS. 23 to 25, the light guide plate 12 has a bottom surface 121 and a light emitting surface 122. A plurality of microstructures are formed on the bottom surface 121 to improve the brightness uniformity. In the FIG. 23, a plurality of V-shaped structures are formed on the bottom surface 121. In the FIG. 24, a plurality of semicircle recesses are formed on the bottom surface 121. In the FIG. 25, a plurality of dots are formed on the bottom surface 121.

Referring to FIG. 26, light paths of the backlight module 1 is shown. The light source 11 emits light beams R1 to enter the light guide plate 12, and the light beams R1 are transmitted to the light guide plate 12. Some light beams R3 exit from the light emitting surface 122 of the light guide plate 12, some light beams R2 exit from the bottom surface 121 of the light guide plate 12 and are reflected by the reflection plate 13 to enter the light guide plate 12 again. The microstructures on the bottom surface 121 can improve the light beams diffusion. The light beams R3 exiting from the emitting surface 122 of the light guide plate 12 are diffused through the first diffusion board 14 and then exit. The light beams R4 exiting from the first diffusion board 14, are concentrated through the first prism sheet 15 and the second prism sheet 16. Finally, the light beams are diffused by the second diffusion board 17 and exit from the backlight module 1.

However, the backlight module 1 requires many elements, including two diffusion boards and two prism sheets, to provide uniformity of the whole backlight module 1. That is, the brightness of the backlight module 1 will be weakened because of the absorbing of the element. Furthermore, the assembly of the backlight module 1 is complex.

What is needed, therefore, is a light guide plate used in a backlight module with high brightness and simple structure.

### SUMMARY

A light guide plate includes a light incident surface, a bottom surface adjoining the light incident surface, and an light emitting surface opposite to the bottom surface. The bottom surface has a plurality of first V-shaped grooves defined therein along a plurality of concentric arcs. The light emitting surface has a plurality of second V-shaped grooves defined therein in parallel with each other.

A method of manufacturing the light guide plates includes the step of: preparing a first light guide plate mold core having a molding surface configured for conforming with a bottom surface of a light guide plate, the light guide plate having a plurality of first V-shaped grooves defined in the bottom surface and arranged along a plurality of concentric arcs; preparing a second light guide plate mold core having a molding surface configured for conforming with a light emitting surface of the light guide plate, the light guide plate having a plurality of second V-shaped grooves defined in the light emitting surface and arranged in parallel with each other; fixing the first and second light guide plate mold cores in a mold; placing a raw material of the light guide plate between the first and second light guide plate mold cores; molding the raw material to make the light guide plate; and removing from mold to achieve the light guide plate including the bottom surface having the plurality of first V-shaped grooves along the plurality of concentric arcs and the light emitting surface having the plurality of second V-shaped grooves in parallel with each other.

Compared with conventional light guide plates, the present light guide plate has several advantages. The present light guide plate is used a backlight module, the backlight module need not include the diffusion board and the prism. The backlight module has a simple structure and assembly easily. The backlight module has a high brightness without the absorbing of the diffusion board and the prism. Furthermore, the cost of the backlight module is decreased.

Other advantages and novel features will become more apparent from the following detailed description of present light guide plate, when taken in conjunction with the accompanying drawings.

### BRIEF DESCRIPTION OF THE DRAWINGS

Many aspects of the present light guide plate and its related manufacturing method can be better understood with reference to the following drawings. The components in the drawings are not necessarily drawn to scale, the emphasis instead being placed upon clearly illustrating the principles of the present light guide plate. Moreover, in the drawings, like reference numerals designate corresponding parts throughout the several views.

FIG. 1 is an isometric view of a backlight module according to a first preferred embodiment of the present invention;

FIG. 2 is a bottom plan view of the backlight module of FIG. 1;

FIG. 3 is an enlarged, cross-sectional view of a light guide plate of FIG. 1;

FIG. 4 is a part-enlarged view of the emitting surface of the light guide plate of FIG. 1;

FIG. 5 is a part-enlarged view of the bottom surface of the light guide plate of FIG. 1;

FIG. 6 is a isometric view of a light guide plate according to a second preferred embodiment of the present invention;

FIG. 7 is a part-enlarged view of the emitting surface of the light guide plate of FIG. 6;

FIG. 8 is an isometric view of a light guide plate according to a third preferred embodiment of the present invention;

FIG. 9 is a bottom plan view of the backlight module according to a fourth preferred embodiment of the present invention;

FIG. 10 is a part-enlarged view of the bottom surface of the light guide plate according to a fifth preferred embodiment of the present invention;

FIG. 11 is a flow chart of a method for manufacturing light guide plates in accordance with a sixth preferred embodiment;

FIG. 12 is a flow chart of a method for manufacturing a light guide plate mold core.

FIG. 13 and FIGS. 15 to 18 are schematic views showing successive stages of the process for manufacturing the light guide plate mold core of FIG. 12;

FIG. 14 is a schematic view of a deep ultraviolet lithography device for manufacturing the light guide mold core of FIG. 12;

FIGS. 19 to 21 are schematic views showing successive stages of the process for manufacturing the light guide plate mold core of FIG. 12;

FIG. 22 is an exploded, isometric view of a conventional backlight module;

FIG. 23 is a schematic, side view of a light guide plate of FIG. 22;

FIG. 24 is a schematic, side view of another light guide plate of FIG. 22;

FIG. 25 is a schematic, side view of another light guide plate of FIG. 22;

FIG. 26 is schematic view showing light paths associated with the backlight module of FIG. 22.

### DETAILED DESCRIPTION OF PREFERRED EMBODIMENT

Reference will now be made to the drawings to describe preferred embodiment of the present backlight module with simple structure, in detail.

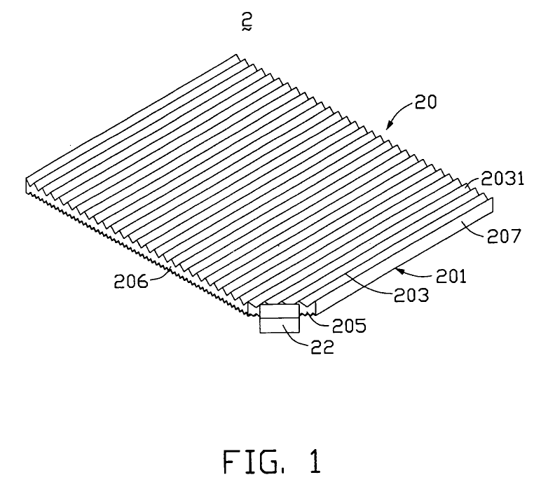

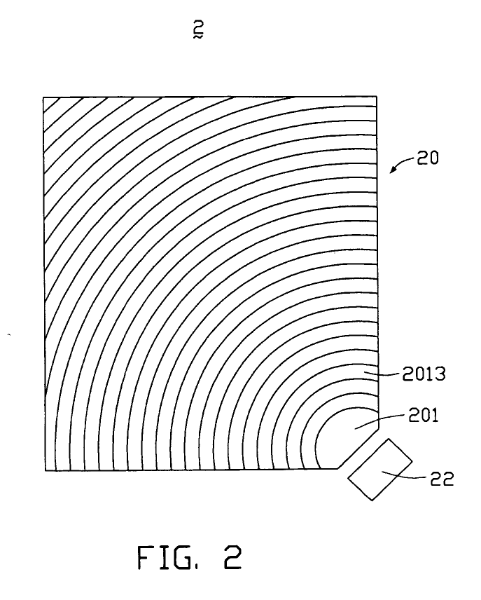

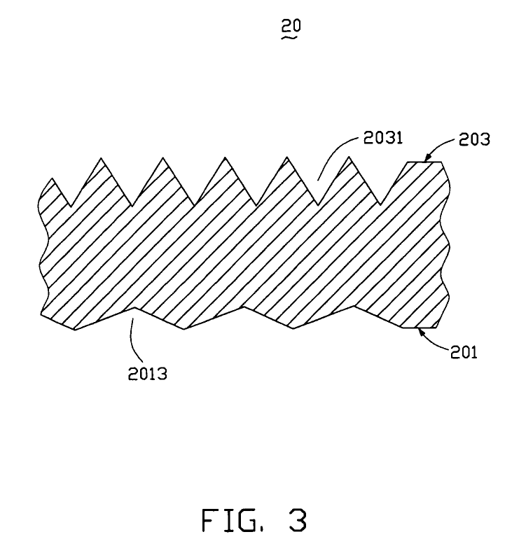

Referring to FIGS. 1 to 3, a backlight module 2 in accordance with a preferred embodiment is shown. The backlight module 2 includes a light source 22 and a light guide plate 20. The light guide plate 20 includes a light incident surface 205 corresponding to the light source 22, a bottom surface 201 adjoining the light incident surface 205 and a light emitting surface 203 opposite to the bottom surface 201. The bottom surface 201 has a plurality of first V-shaped grooves 2013 defined therein along a plurality of concentric arcs. The light emitting surface 203 has a plurality of second V-shaped grooves 2031 defined therein in parallel with each other. In this preferred embodiment, the second V-shaped grooves 2031 as a group, are contiguous. The first V-shaped grooves 2013 as a group, are contiguous. The light guide plate further includes two main side surfaces 206, 207, the light incident surface 205 obliquely interconnects the two main side surfaces 206, 207.

The light guide plate 20 can be made of polymethyl methacrylate (PMMA) or polycarbonate (PC).

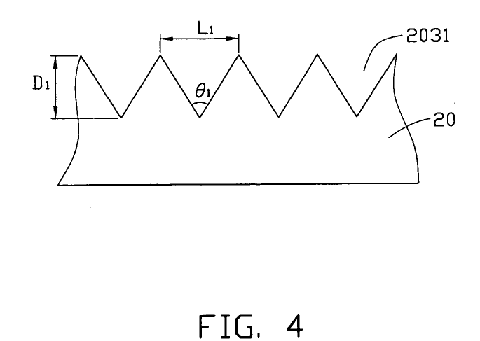

Referring to FIG. 4, each of the second V-shaped grooves 2031 defines a depth D₁, a width L₁ and a groove angle θ₁. The depth D₁ is in a range from 1 to 8 micrometers, the width L₁ is in a range from 10 to 20 micrometers and the groove angle θ₁ is in a range of 80 to 130 degree.

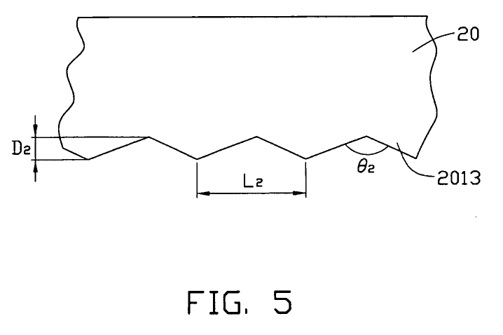

Referring to FIG. 5, each of the first V-shaped grooves defines a width L₂, a depth D₂ and a groove angle θ₂. The width L₂ is in a range from 10 to 20 micrometers, the depth D₂ is in a range from 1 to 2 micrometers, and the angle θ₂ is in a range of 130 to 160 degrees. The groove angles θ₂ of the first V-shaped grooves are equal to each other.

In operation, because the light guide plate 20 has the plurality of first V-shaped grooves 2013 formed on the bottom surface 201 and the plurality of second V-shaped grooves 2031 formed on the light emitting surface 203, the light beams emitted from the light source 22 can be diffused by the first V-shaped grooves 2013 formed on the bottom surface 201 and concentrated to exit from the light emitting surface 203 by the second V-shaped grooves 2031 formed on the light emitting surface 203.

Therefore, the present backlight module 2 need not include the diffusion board and the prism. The present backlight module 2 has a simple structure and easy assembly. The present backlight module 2 has a higher brightness as it avoids the absorption of light by the diffusion board and the prism. Furthermore, the cost of the present backlight module 2 is decreased.

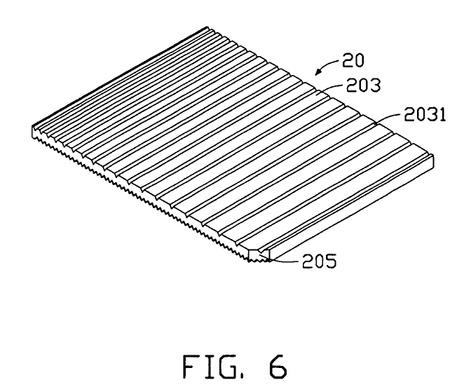

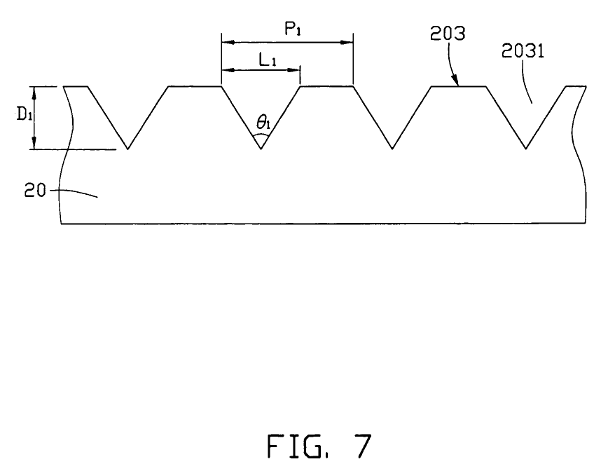

Referring to FIGS. 6 and 7, a light guide plate 20 in accordance with a second preferred embodiment is shown. The light guide plate 20 in accordance with the second preferred embodiment is similar to the first embodiment, except that the second V-shaped grooves 2031 formed on the light emitting surface 203 are spaced apart from each other. A distance P₁ is defined between each of V-shaped grooves 2031 and its neighbouring grooves 2031. The distance P₁ is in a range from 10 to 40 micrometers. The distance P₁ is reduces with distance as away from the incident surface 205.

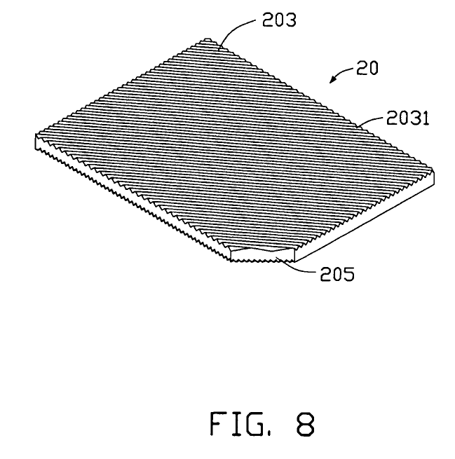

Referring to FIG. 8, a light guide plate 20 in accordance with a third preferred embodiment is shown. The light guide plate 20 in accordance with the third preferred embodiment is similar to the first embodiment, except that the second V-shaped grooves 2031 extend in parallel with the light incident surface 205.

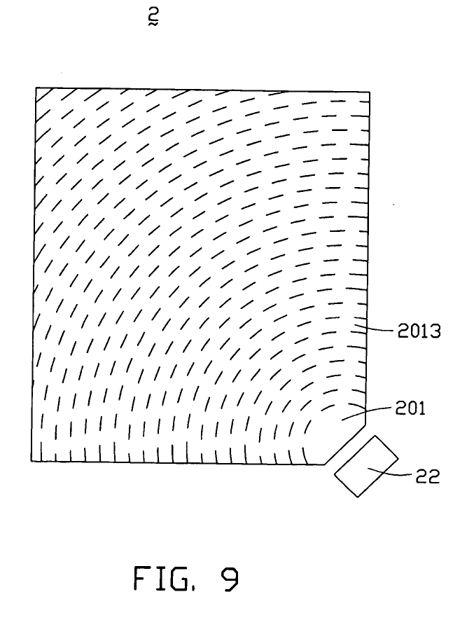

Referring to FIG. 9, a backlight module 2 in accordance with a fourth preferred embodiment is shown. The backlight module 2 in accordance with the fourth preferred embodiment is similar to the first embodiment, except that the first V-shaped grooves 2013 formed on the bottom surface 201 as a group, are spaced apart from each other.

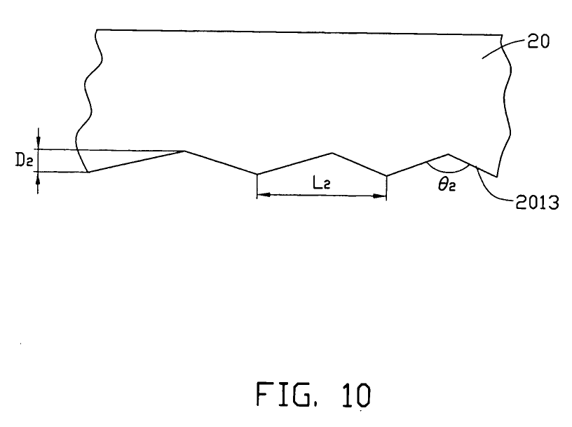

Referring to FIG. 10, a light guide plate 20 in accordance with a fifth preferred embodiment is shown. The light guide plate 20 in accordance with the fifth preferred embodiment is similar to the first embodiment, except that the groove angles θ₂ of the first V-shaped groove 2013 progressively decrease with increasing distance from the light incident surface 205.

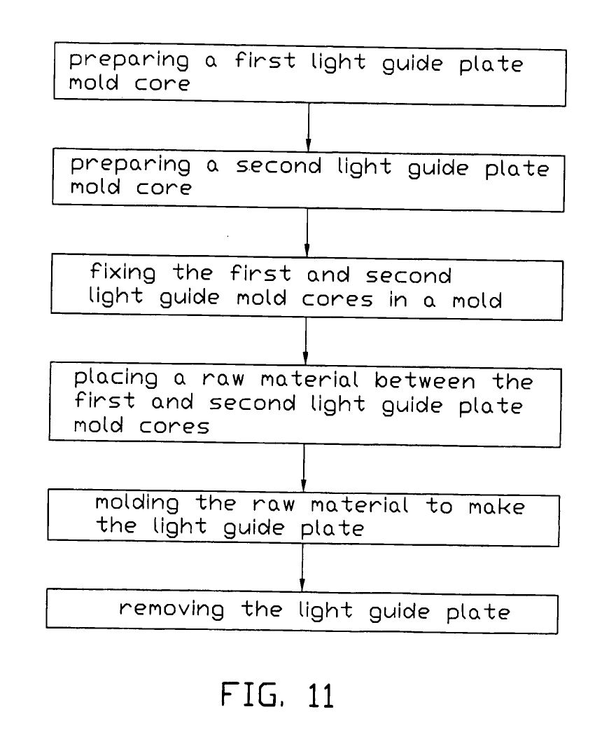

Referring to FIG. 11, a method of manufacturing light guide plates in accordance with a sixth preferred embodiment is shown. The method of manufacturing a light guide plate includes the following step:
(A) preparing a first light guide plate mold core having a molding surface configured for conforming with a bottom surface of the light guide plate, the light guide plate having a plurality of first V-shaped grooves defined in the bottom surface and arranged along a plurality of concentric arcs;
(B) preparing a second light guide plate mold core having a molding surface configured for conforming with a light emitting surface of the light guide plate, the light guide plate having a plurality of second V-shaped grooves defined in the light emitting surface and arranged in parallel with each other;
(C) fixing the first and second light guide plate mold cores in a mold;
(D) placing a raw material of the light guide plate between the first and second light guide plate mold cores;
(E) molding the raw material to make the light guide plate;
(F) removing from the mold to achieve the light guide plate including the bottom surface having the plurality of first V-shaped grooves along the plurality of concentric arcs and the light emitting surface having the plurality of second V-shaped grooves in parallel with each other.

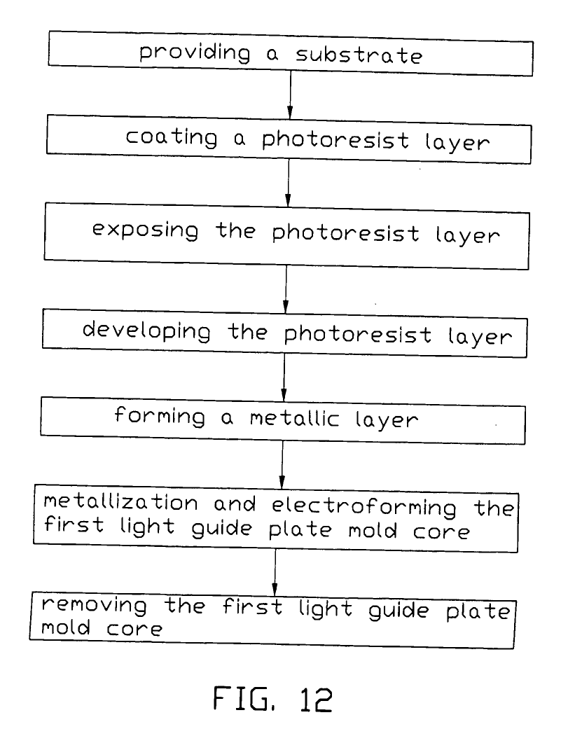

Referring to FIG. 12, the step (A) further includes the following steps:
(a) providing a substrate;
(b) coating a photoresist layer on the substrate;
(c) exposing the photoresist layer using a mask by a deep ultraviolet (UV) lithography process;
(d) developing the photoresist layer to form a patterned surface configured for conforming a contour of the bottom surface of the light guide plate;
(e) forming a metallic layer on the patterned surface of the photoresist layer;
(f) metallizating the metallic layer and electroforming the first light guide plate mold core on the photoresist layer; and
(g) removing the first light guide plate mold core from the substrate, the first light guide plate mold core having the metallic layer thereon.

In the step (a), a substrate 30 is provided.

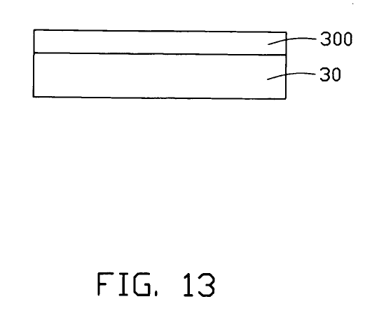

Referring to FIG. 13, in the step (b), a photoresist layer 300 is coated on the substrate 30.

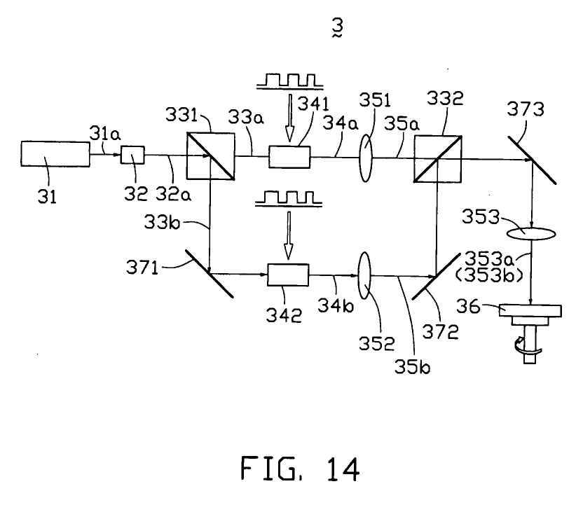

Referring to FIG. 14, in the step (c), a deep ultraviolet lithography device 3 is provided to expose the photoresist layer 300.

The deep ultraviolet lithography device 3 is a device to emit the deep ultraviolet laser beams required to form the optical pattern in the photoresist layer 300. The deep ultraviolet lithography device 3 includes a beam laser source 31, a beam filter 32, a beam spliter 331, beam combiner 332, a first opto-acoustic modulator (OAM) 341, a second OAM 342, a first numerical aperture lens (NAL) 351, a second NAL 352, a third NAL 353, a rotating table 36, a first reflective mirror 371, a second reflective mirror 372, and a third reflective mirror 373. The third reflective mirror 373, the third NAL 353 and the rotating table 36 are combined to form a focus device. The substrate 30 coating the photoresist layer 300 is arranged on the rotating table 36.

In operation, a laser beam 31a emitted from the beam laser source 31, is filtered so that only the laser beam 32a of 257 nanometers wave length is left by the beam filter 32. The laser beam 32a passes through the beam spliter 331 and divides into a transmission laser beam 33a and a reflective laser beam 33b.

The transmission laser beam 33a passes through the first OAM 341, and achieves a laser beam 34a having a certain phase frequency. The laser beam 34a converts into a parallel laser beam 35a after passing through the first NAL 351. The laser beam 35a passes through the beam combiner 332, and is reflected by the third reflective mirror 373 to the third NAL 353 for achieve a concentrated laser beam 353a. The concentrated laser beam 353a is transmitted directly to the photoresist layer 300 of the substrate 30 arranged on the rotating table 36 to form the optical pattern.

The reflective laser beam 33b is reflected by the first reflective mirror 371 and passes through the second OAM 342 to achieve a laser beam 34b having a certain phasic frequency. The laser beam 34b convert into a parallel laser beam 35b after passing through the second NAL 352. The parallel laser beam 35b is reflected by the second reflective mirror 372 to pass through the beam combiner 332 and then be reflected by the third reflective mirror 373 to irradiate to the third NAL 353 to achieve a concentrated laser beam 353b. The concentrated laser beam 353b is transmitted directly to the photoresist layer 300 to form the optical pattern.

The first NAL 351, the second NAL 352 and the third NAL 353 can adjust the aperture parameter of the laser beam to achieve a high precision light guide plate.

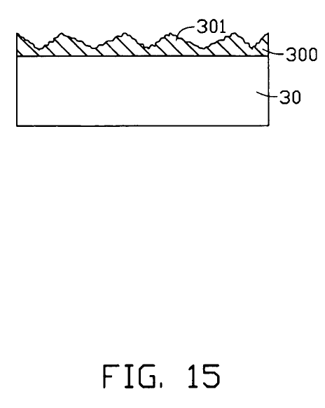

Referring to FIG. 15, after the step (d), a patterned surface 301 are formed on the photoresist layer 300 configured for conforming a contour of the bottom surface of the light guide plate.

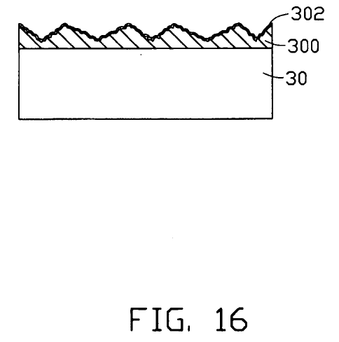

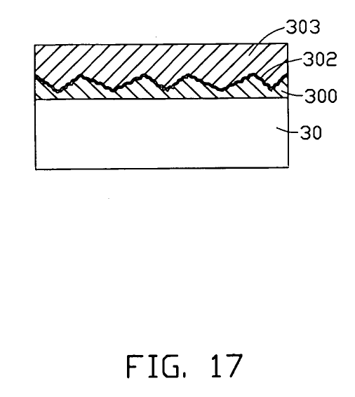

Referring to FIGS. 16 and 17, in the step (e), a metal layer 302 is formed on the patterned surface 301. The metal layer 302 is made of metal material, such as nickel. The metal layer 302 can then be electroformed to form a first light guide plate mold core 303.

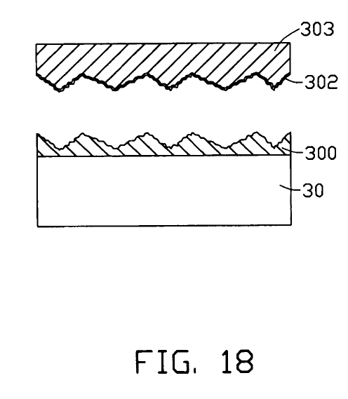

Referring to FIG. 18, in the step (f), the first light guide plate mold core 303 is removed from the substrate 30 coating the photoresist layer 300. The first light guide plate mold core 303 has the metallic layer 302 thereon.

The step (B) is similar to the step (A), except that the photoresist layer is developed to form a patterned surface configured for conforming a contour of the light emitting surface of the light guide plate.

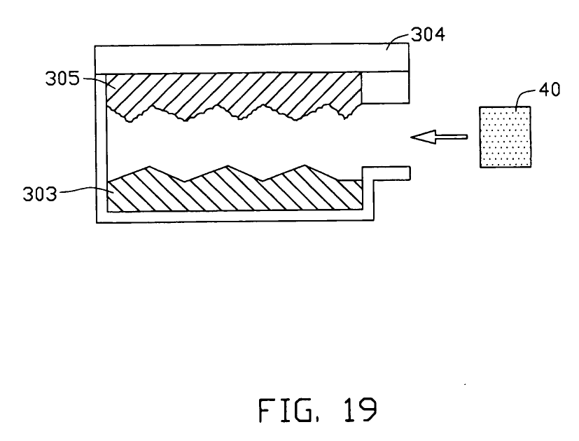

Referring to FIG. 19, in the step (C), the first and second light guide plate mold cores 303, 305 are fixed in a mold 304.

In the step (D), the raw material 40 of light guide plate is placed between the first and second light guide plate mold cores 303, 305. The raw material can be polymethyl methacrylate or polycarbonate.

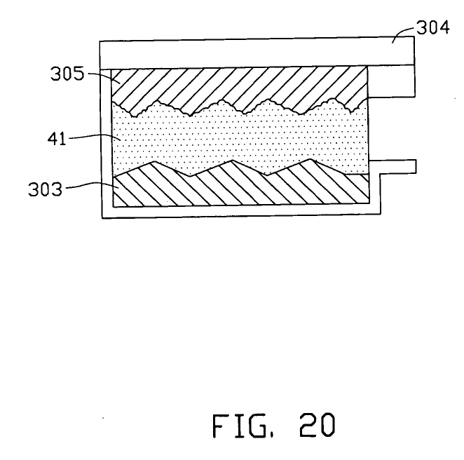

Referring to FIG. 20, in the step (E), the mold 304 is locked. The first V-shaped grooves are formed on the bottom surface of the light guide plate 41 and the second V-shaped grooves are formed on the light emitting surface of the light guide plate 41.

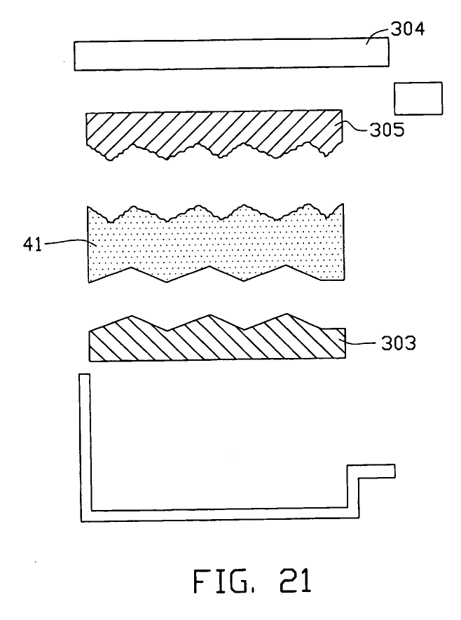

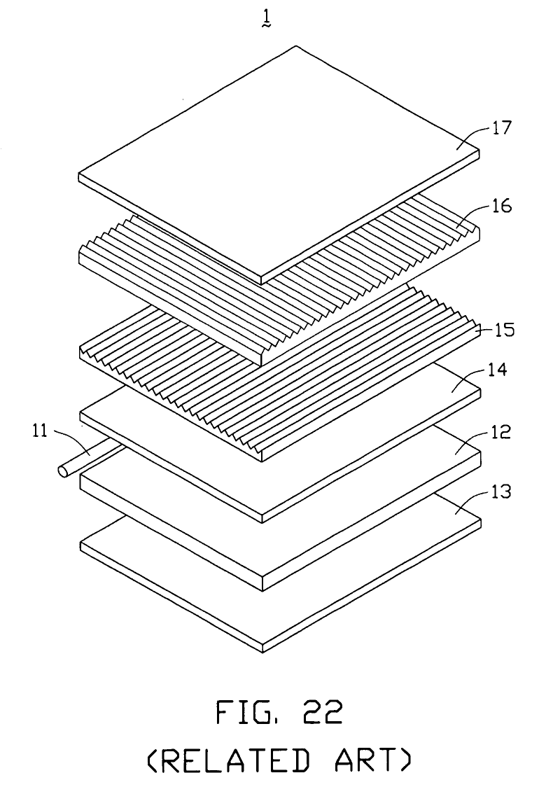

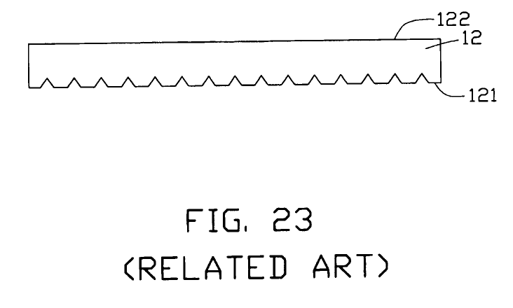

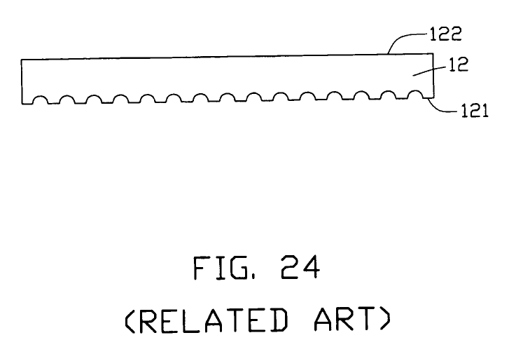

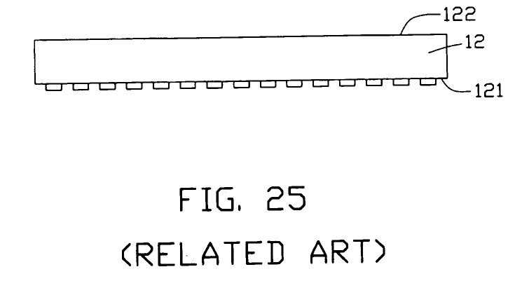

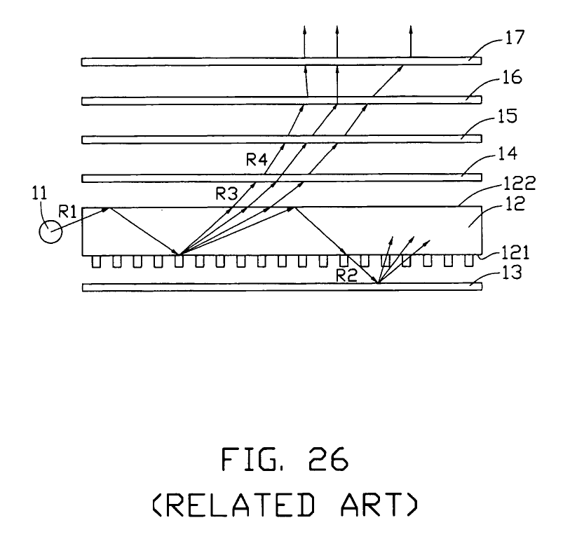

Referring to FIG. 21, in the step (F), the light guide plate 41 is removed form the mold 304, and the light guide plate 41 includes the bottom surface having the plurality of first V-shaped grooves along the plurality of concentric arcs and the light emitting surface having the plurality of second V-shaped grooves in parallel with each other.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A light guide plate, comprising:
a light incident surface;
a bottom surface adjoining the light incident surface, the bottom surface having a plurality of first V-shaped grooves defined therein along a plurality of concentric arcs;
a light emitting surface opposite to the bottom surface, the light emitting surface having a plurality of second V-shaped grooves defined therein in parallel with each other.

2. The light guide plate as claimed in claim 1, wherein the second V-shaped grooves as a group are contiguous.

3. The light guide plate as claimed in claim 1, wherein the second V-shaped grooves are spaced apart from each other.

4. The light guide plate as claimed in claim 1, wherein the second V-shaped grooves extend in parallel with the light incident surface.

5. The light guide plate as claimed in claim 1, wherein each of the second V-shaped grooves defines a width in a range from 10 to 20 micrometers, a depth in a range from 1 to 8 micrometers, and a groove angle in a range from 80 to 130 degrees.

6. The light guide plate as claimed in claim 6, wherein the first V-shaped grooves are contiguous.

7. The light guide plate as claimed in claim 6, wherein the first V-shaped grooves are spaced apart from each other.

8. The light guide plate as claimed in claim 1, wherein each of the first V-shaped grooves defines a width in the range from 10 to 20 micrometers, a depth in a range from 1 to 2 micrometers, and a groove angle in a range from 130 to 160 degrees.

9. The light guide plate as claimed in claim 8, wherein the groove angles of the first V-shaped grooves are equal to each other.

10. The light guide plate as claimed in claim 8, wherein the groove angles of the first V-shaped grooves progressively decrease with increasing distance from the light incident surface.

11. The light guide plate as claimed in claim 1, further comprising two main side surfaces, the light incident surface obliquely interconnecting the two main side surfaces.

12. A method of manufacturing a light guide plate, comprising the steps of:
(A) preparing a first light guide plate mold core having a molding surface configured for conforming with a bottom surface of the light guide plate, the light guide plate having a plurality of first V-shaped grooves defined in the bottom surface and arranged along a plurality of concentric arcs;
(B) preparing a second light guide plate mold core having a molding surface configured for conforming with a light emitting surface of the light guide plate, the light guide plate having a plurality of second V-shaped grooves defined in the light emitting surface and arranged in parallel with each other;
(C) fixing the first and second light guide plate mold cores in a mold;
(D) placing a raw material of the light guide plate between the first and second light guide plate mold cores;
(E) molding the raw material to make the light guide plate;
(F) removing from the mold to achieve the light guide plate including the bottom surface having the plurality of first V-shaped grooves along the plurality of concentric arcs and the light emitting surface having the plurality of second V-shaped grooves in parallel with each other.

13. The method as claimed in claim 12, wherein the raw material of the light guide plate is selected from one of polymethyl methacrylate and polycarbonate.

14. The method as claimed in claim 13, wherein the step for preparing one of first and second light guide plate mold cores further comprises the following steps:
(a) providing a substrate;
(b) coating a photoresist layer on the substrate;
(c) exposing the photoresist layer using a mask by a deep ultraviolet lithography process;
(d) developing the photoresist layer to form a pattern surface configured for conforming a contour of one of the bottom surface and the light emitting surface of the light guide plate;
(e) forming a metallic layer on the patterned surface of the photoresist layer;
(f) metallizating the metallic layer and electroforming the one of first and second light guide plate mold cores on the photoresist layer; and
(g) removing the one of first and second light guide plate mold cores from the substrate, the one of first and second light guide plate mold cores each having the metallic layer thereon.

15. The method as claimed in claim 14, wherein the deep ultraviolet lithography process utilizes laser beams with a wavelength of 257 nanometers to expose the photoresist layer.
